(19) United States
(12) Patent Application Publication
(10) Pub. No.: US 2026/0255215 A1
(43) Pub. Date: Aug. 27, 2026

(54) PDCP DISCARD MECHANISM FOR EXTENDED REALITY IN WIRELESS NETWORK

(71) Applicant: Samsung Electronics Co., Ltd., Suwon-si, Gyeonggi-do (KR)

(72) Inventors: Vinay Kumar SHRIVASTAVA, Bangalore (IN); Sriganesh RAJENDRAN, Bangalore (IN); Aby Kanneath ABRAHAM, Bangalore (IN)

(21) Appl. No.: 18/992,034

(22) PCT Filed: Jul. 13, 2023
(86) PCT No.: PCT/KR2023/009990

§ 371 Date: Jan. 7, 2025

(30) Foreign Application Priority Data
Jul. 15, 2022 (IN) 202241040680
Jun. 16, 2023 (IN) 2022 41040680

(51) Int. Cl. H04W 28/06; H04W 76/20

(52) U.S. Cl. CPC H04W 28/06; H04W 76/20

(57) ABSTRACT

The disclosure relates to a 5G or 6G communication system for supporting a higher data transmission rate. Accordingly, embodiments herein disclose a method for discarding PDCP packets for an XR in wireless network (1000) by transmitter (100). The method includes detecting whether a XR discard timer for a PDU Set is expired. In an embodiment, the method includes discarding the subsequent SDU/PDU of the PDU Set, when the XR discard timer for the first SDU/PDU of the PDU Set is expired wherein at least one subsequent SDU/PDU of the PDU Set is already received at the PDCP entity or discarding is done at the time of receiving the subsequent SDU/PDU of the PDU Set at the PDCP entity. In another embodiment, the method includes mapping the subsequent SDU/PDU of the PDU Set to XR discard timer per SDU/PDU, when the XR discard timer for the first SDU/PDU of the PDU Set is not expired at the time of receiving the subsequent SDU/PDU of the PDU Set at the PDCP entity.

### TECHNICAL FIELD

This application is based on and derives the benefit of Indian Provisional Application 20/224,1040680 filed on 15 Jul. 2022, the contents of which are incorporated herein by reference. The present disclosure relates to a wireless network, and more specifically related to a Packet Data Convergence Protocol (PDCP) discard mechanism for extended reality (XR) in the wireless network.

### BACKGROUND ART

Extended Reality (XR) is an umbrella term for different realities including Virtual Reality (VR), Augmented Reality (AR) and Mixed Reality (MR), and is considered as an essential technology to enable the realization of digital twin/meta universe. The XR is incorporated as an agreed work item in a fifth generation (5G) Advanced (i.e. Third Generation Partnership Project (3GPP) Release 18), which is targeted to provide a communication system framework that fulfills challenging needs of high data rate, very low latency and power efficient connectivity for an XR application.

Protocol Data Convergence Protocol (PDCP) is a layer-2 sub-layer and is involved in a number of functionalities for a data plane processing of transmitted packets and received packets. The functionalities include but not limited to Service Data Unit (SDU) discard, ciphering and integrity protection, header compression on a transmitting side and reordering, deciphering and integrity verification, duplicate discarding, header decompression on a receiving side. Each radio bearer (RB) is associated with a transmitting PDCP entity and/or a receiving PDCP entity. A SDU discard procedure involves discard of the PDCP SDU when an associated timer is expired or the successful delivery of a PDCP SDU is confirmed from a peer PDCP entity e.g. through a PDCP status report.

For the XR applications, the existing PDCP SDU discard may not be efficient and effective as the XR applications are more tightly coupled with the frame transmission, and not with an internet protocol (IP) packet transmission which is typically one-to-one mapped to a PDCP SDU. As a result, existing mechanism may lead to an in-efficient SDU discard operation, excessive processing burden and/or transmission resource wastage and so on. Thus, it is desired to address the above mentioned disadvantages or other shortcomings or at least provide a useful alternative for a PDCP discard mechanism for XR in the wireless network.

Also, 5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The principal object of the embodiments herein is to disclose a method and a wireless network for discarding a PDCP for an extended reality (XR) in the wireless network.

Another object of the embodiment herein is to manage PDCP reordering and delivery for XR in the wireless network.

Another object of the embodiment herein is to configure PDCP for the XR in the wireless network.

Another object of the embodiment herein is to provide a signaling frame based packet mapping information for the XR in the wireless network.

Another object of the embodiment herein is to provide a PDCP discard for XR considering PDU Set based discard procedure.

Another object of the embodiment herein is to provide a radio resource control (RRC) signalling for a XR discard timer configuration and timer operation.

Another object of the embodiment herein is to provide a PDCP header based information for a PDU Set.

Another object of the embodiment herein is to provide a receiver operation for XR based on in-order or out of order treatment for the PDU Set.

Another object of the embodiment herein is to provide a differential discard operation for different PDU Sets or frames of a XR service.

### Solution to Problem

Accordingly, embodiments herein disclose a method for discarding PDCP packets for an XR in a wireless network. The method includes receiving, by a transmitter, a first SDU/PDU of a PDU Set at a PDCP entity from an upper layer of an apparatus (e.g., UE or the network apparatus). Further, the method includes starting, by the transmitter, a XR discard timer for the PDU Set upon receiving the first SDU/PDU at the PDCP entity. Further, the method includes mapping, by the transmitter, the first SDU/PDU of the PDU Set to the XR discard timer. Further, the method includes storing, by the transmitter, the first SDU/PDU of the PDU Set at a PDCP buffer. Further, the method includes receiving, by the transmitter, a subsequent SDU/PDU that belongs to the same PDU set at the PDCP entity from the upper layer of the apparatus. Further, the method includes detecting, by the transmitter, whether the XR discard timer for the PDU set is expired. In an embodiment, the method includes discarding the subsequent SDU/PDU of the PDU Set, when the XR discard timer for the first SDU/PDU of the PDU Set is expired wherein at least one subsequent SDU/PDU of the PDU Set is already received at the PDCP entity or discarding is done at the time of receiving the at least one subsequent SDU/PDU of the PDU Set at the PDCP entity. In another embodiment, the method includes mapping the subsequent SDU/PDU of the PDU Set to an XR discard timer per SDU/PDU, when the XR discard timer for the first SDU/PDU of the PDU Set is not expired at the time of receiving the subsequent SDU/PDU of the PDU Set at the PDCP entity, and storing the subsequent SDU/PDU of the PDU Set at the PDCP buffer.

In an embodiment, the method includes detecting, by the transmitter, that the XR discard timer for the PDU Set is expired or loss of at least one SDU/PDU constituting the PDU Set or a successful delivery of all SDU/PDU constituting the PDU Set. Further, the method includes discarding, by the transmitter, the PDU Set including the first SDU/PDU and the subsequent SDU/PDU mapped to the XR discard timer for the PDU Set, when the XR discard timer for the PDU Set is expired or loss of at least one SDU/PDU constituting the PDU Set is detected or the successful delivery of all SDU/PDU constituting the PDU Set is detected.

In an embodiment, the method includes detecting, by the transmitter, that the XR discard timer for the at least one SDU/PDU of the PDU Set is expired or loss of at least one SDU/PDU constituting the PDU Set or a successful delivery of all SDU/PDU constituting the PDU Set. Further, the method includes discarding, by the transmitter, the PDU Set including the first SDU/PDU and the subsequent SDU/PDU for the PDU Set, when the XR discard timer for the at least one SDU/PDU of the PDU Set is expired or loss of at least one SDU/PDU constituting the PDU Set is detected or a successful delivery of all SDU/PDU constituting the PDU Set is detected.

In an embodiment, the method includes adding, by the transmitter, in a PDCP header in each SDU/PDU at least one of a frame start indication representing the first SDU/PDU of the PDU Set, frame continuation indication representing the subsequent SDU/PDU of the PDU Set, and a frame end indication representing the last SDU/PDU of the PDU Set. Further, the method includes sending, by the transmitter, at least one of the first SDU/PDU and the subsequent SDU/PDU belonging to the same PDU Set to a receiver.

In an embodiment, starting, by the transmitter, the XR discard timer for the PDU Set upon receiving the first SDU/PDU at the PDCP entity includes receiving, by the transmitter, a XR radio bearer configuration in the Radio Resource Control (RRC) signaling from a network apparatus, where the XR radio bearer configuration includes at least one of the XR discard timer configuration and a PDU Set integrated handling indication (or may be termed as PDU-Set discard indication for the PDCP entity) indicating whether discarding of the PDU Set is allowed at the transmitter; and one of: the method includes starting, by the transmitter, the XR discard timer for the PDU Set upon receiving the first SDU/PDU at the PDCP entity, and starting, by the transmitter, the XR discard timer for the SDU/PDU of the PDU Set upon receiving the respective SDU/PDU of the PDU Set at the PDCP entity

In an embodiment, discarding the first SDU/PDU and the subsequent SDU/PDU of the PDU Set includes detecting, by the transmitter, whether a PDU Set integrated handling indication indicates that the discarding of the PDU Set is allowed at the transmitter; and one of: discarding the first SDU/PDU and the subsequent SDU/PDU of the PDU Set when the PDU Set integrated handling indication indicates that the discarding of the PDU Set is allowed at the transmitter, and discarding the respective SDU/PDU when the PDU Set integrated handling indication indicates that the discarding of the PDU Set is not allowed at the transmitter.

In an embodiment, the transmitter is configured with at least one discard timer value for different frame types, wherein the transmitter starts the XR discard timer with an appropriate discard timer value based on a type of a frame associated with the SDU.

Accordingly, embodiments herein disclose a method for discarding PDCP packets for XR in a wireless network. The method includes receiving, by a receiver, a XR radio bearer configuration in the Radio Resource Control (RRC) signaling from a network apparatus. The XR radio bearer configuration includes a frame delivery allowed indication indicating whether a completely received PDU Set is allowed to be delivered from the receiver is configured. Further, the method includes receiving, by the receiver, a plurality of SDU/PDU that belongs to a PDU Set, where a PDCP header in each of the SDU/PDU includes at least one of a frame start indication representing the first SDU/PDU of the PDU Set, frame continuation indication representing the subsequent SDU/PDU of the PDU Set, and a frame end indication representing the last SDU/PDU of the PDU Set. Further, the method includes detecting, by the receiver, whether the frame delivery allowed indication indicates PDU/SDU is allowed to be delivered from the receiver is configured. In an embodiment, the method includes delivering the plurality of SDU/PDU that belongs to the PDU Set to an upper layer entity after the complete PDU Set is received when the frame delivery allowed indication indicates a completely received PDU Set is allowed to be delivered from the receiver is configured. In another embodiment, the method includes reordering the plurality of SDU/PDU that belongs to the PDU Set based on the PDCP header of the SDU/PDU when the frame delivery allowed indication indicates a completely received PDU Set is allowed to be delivered from the receiver is not configured, and delivering each SDU/PDU of the plurality of SDU/PDU that belongs to the PDU Set to the upper layer entity based on the reordering.

In an embodiment, delivering each SDU/PDU of the plurality of SDU/PDU that belongs to the PDU Set to the upper layer entity based on the reordering timer expiry includes decompressing, by the receiver, the PDCP header based on at least one of all stored SDU/PDU pertaining to completely received PDU Set with associated COUNT value less than RX_REORD, and all stored SDU/PDU pertaining to completely received PDU Set with associated COUNT value starting from RX_REORD, where the RX_REORD indicates the COUNT value following the COUNT value associated with the PDCP Data PDU which triggered reordering timer, discarding, by the receiver, all the stored SDU/PDU pertaining to not completely received PDU Set with associated COUNT value(s) less than RX_REORD, delivering each SDU/PDU of the plurality of SDU/PDU that belongs to the completely received PDU Set in ascending order of the associated COUNT value to the upper layer entity, updating RX_DELIV to the COUNT value of the first SDU/PDU which has not been delivered to upper layers, with COUNT value greater than or equal to RX_REORD, where the RX_DELIV indicates the COUNT value of the first PDCP SDU not delivered to the upper layers, and updating, by the receiver, RX_REORD to RX_NEXT and starting a reordering timer, if RX_DELIV is less than RX_NEXT, where the RX_NEXT indicates the COUNT value of the next PDCP SDU expected to be received.

Accordingly, embodiments herein disclose a transmitter for discarding PDCP for XR in a wireless network. The transmitter includes a PDCP discard controller communicatively coupled to a memory and a processor. The PDCP discard controller is configured to receive a first SDU/PDU of a PDU Set at a PDCP entity from an upper layer of an apparatus. Further, the PDCP discard controller is configured to start a XR discard timer for the PDU Set upon receiving the first SDU/PDU at the PDCP entity. Further, the PDCP discard controller is configured to map the first SDU/PDU of the PDU Set to the XR discard timer. Further, the PDCP discard controller is configured to store the first SDU/PDU of the PDU Set at a PDCP buffer. Further, the PDCP discard controller is configured to receive a subsequent SDU/PDU that belongs to the same PDU Set at the PDCP entity from the upper layer entity of the apparatus. Further, the PDCP discard controller is configured to detect whether the XR discard timer for the PDU Set is expired. In an embodiment, the PDCP discard controller is configured to discard the subsequent SDU/PDU of the PDU Set, when the XR discard timer for the first SDU/PDU of the PDU Set is expired wherein at least one subsequent SDU/PDU of the PDU Set is already received at the PDCP entity or discarding is done at the time of receiving the at least one subsequent SDU/PDU of the PDU Set at the PDCP entity. In another embodiment, the PDCP discard controller is configured to map the subsequent SDU/PDU of the PDU Set to the XR discard timer per SDU/PDU, when the XR discard timer for the first SDU/PDU of the PDU Set is not expired at the time of receiving the subsequent SDU/PDU of the PDU Set at the PDCP entity, and storing the subsequent SDU/PDU of the PDU Set at the PDCP buffer.

Accordingly, embodiments herein disclose a receiver for discarding PDCP for a XR in a wireless network. The receiver includes a PDCP discard controller communicatively coupled to a memory and a processor. The PDCP discard controller is configured to receive a XR radio bearer configuration in the Radio Resource Control (RRC) signaling from a network apparatus. The XR radio bearer configuration includes a frame delivery allowed indication indicating whether a completely received PDU Set is allowed to be delivered from the receiver is configured. Further, the PDCP discard controller is configured to receive a plurality of SDU/PDU that belongs to a PDU Set. A PDCP header in each of the SDU/PDU includes at least one of a frame start indication representing the first SDU/PDU of the PDU Set, frame continuation indication representing the subsequent SDU/PDU of the PDU Set, and a frame end indication representing the last SDU/PDU of the PDU Set. Further, the PDCP discard controller is configured to detect whether the frame delivery allowed indication indicates PDU/SDU is allowed to be delivered from the receiver. In an embodiment, the PDCP discard controller is configured to deliver the plurality of SDU/PDU that belongs to the PDU Set to an upper layer entity after the complete PDU Set is received when the frame delivery allowed indication indicates a completely received PDU Set is allowed to be delivered from the receiver is configured. In another embodiment, the PDCP discard controller is configured to reorder the plurality of SDU/PDU that belongs to the PDU Set based on the PDCP header of the SDU/PDU when the frame delivery allowed indication indicates a completely received PDU Set is allowed to be delivered from the receiver is not configured, and delivering each SDU/PDU of the plurality of SDU/PDU that belongs to the PDU Set to the upper layer entity based on the reordering.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### Advantageous Effects of Invention

According to an embodiment of the disclosure, wireless network for discarding a PDCP for an extended reality (XR) can be performed efficiently.

### BRIEF DESCRIPTION OF DRAWINGS

The method and the wireless network are illustrated in the accompanying drawings, throughout which like reference letters indicate corresponding parts in the various figures. The embodiments herein will be better understood from the following description with reference to the drawings, in which:

FIG. 1 illustrates a wireless network for discarding PDCP packets for an XR, according to embodiments as disclosed herein;

FIG. 2 shows various hardware components of a transmitter, according to the embodiments as disclosed herein;

FIG. 3 shows various hardware components of a receiver, according to the embodiments as disclosed herein;

FIG. 4 is a flow chart illustrating a method, implemented by the transmitter, for discarding the PDCP packets for the XR in the wireless network, according to embodiments as disclosed herein;

FIG. 5 is a flow chart illustrating a method, implemented by the receiver, for discarding the PDCP packets for the XR in the wireless network, according to embodiments as disclosed herein;

FIG. 6 is a flow chart illustrating a PDCP discard mechanism at a transmitting PDCP entity (i.e., transmitter) for the XR in the wireless network, according to embodiments as disclosed herein;

FIG. 7 is a flow chart illustrating a PDCP discard mechanism at the transmitting PDCP entity for XR based on a configuration parameter in the wireless network, according to embodiments as disclosed herein;

FIG. 8 is a flow chart illustrating a PDCP reordering and delivery mechanism at a receiving PDCP entity (i.e., receiver) for the XR in the wireless network, according to embodiments as disclosed herein;

FIG. 9 is a flow chart illustrating a method for conveying frame-PDCP SDU mapping information for the XR in the wireless network, according to embodiments as disclosed herein;

FIG. 10 is a flow chart illustrating a PDCP delivery mechanism upon reordering timer expiry at the transmitting PDCP entity for the XR in the wireless network, according to embodiments as disclosed herein; and

FIG. 11 illustrates a various sample XR bearer data PDU format with one or more sequence number, and frame indicator field sub-sequence number field, according to embodiments as disclosed herein.

FIG. 12 illustrates a various sample XR bearer data PDU format with one or more sequence number, and frame indicator field sub-sequence number field, according to embodiments as disclosed herein.

FIG. 13 illustrates a various sample XR bearer data PDU format with one or more sequence number, and frame indicator field sub-sequence number field, according to embodiments as disclosed herein.

FIG. 14 illustrates a various sample XR bearer data PDU format with one or more sequence number, and frame indicator field sub-sequence number field, according to embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In the embodiments of the invention, the terms and the classifications like frame, XR frame, SDU Set, PDU Set, group of packets and slice can be used interchangeably. Further, in the embodiments of the invention, the terms like priority and importance can be used interchangeably. Further, in the embodiments of the invention, the terms like XR radio bearer, radio bearer and data radio bearer can be used interchangeably. Therefore, these terms need to be considered without the loss of generality or specificity.

Accordingly, embodiments herein disclose a method for discarding PDCP packets for an XR in a wireless network. The method includes receiving, by a transmitter, a first SDU/PDU of a PDU Set at a PDCP entity from an upper layer of an apparatus. Further, the method includes starting, by the transmitter, a XR discard timer for the PDU Set upon receiving the first SDU/PDU at the PDCP entity. Further, the method includes mapping, by the transmitter, the first SDU/PDU of the PDU Set to the XR discard timer. Further, the method includes storing, by the transmitter, the first SDU/PDU of the PDU Set at a PDCP buffer. Further, the method includes receiving, by the transmitter, a subsequent SDU/PDU that belongs to the same PDU Set at the PDCP entity from the upper layer entity of the apparatus. Further, the method includes detecting, by the transmitter, whether the XR discard timer for the PDU Set is expired. In an embodiment, the method includes discarding the subsequent SDU/PDU of the PDU Set, when the XR discard timer for the first SDU/PDU of the PDU Set is expired wherein at least one subsequent SDU/PDU of the PDU Set is already received at the PDCP entity or discarding is done at the time of receiving the at least one subsequent SDU/PDU of the PDU Set at the PDCP entity. In another embodiment, the method includes mapping the subsequent SDU/PDU of the PDU Set to an XR discard timer per SDU/PDU, when the XR discard timer for the first SDU/PDU of the PDU Set is not expired at the time of receiving the subsequent SDU/PDU of the PDU Set at the PDCP entity, and storing the subsequent SDU/PDU of the PDU Set at the PDCP buffer.

The proposed method can be used to manage PDCP reordering and delivery for the extended reality in the wireless network. The proposed method can be used to configure the PDCP for the extended reality in the wireless networks. The method proposed method can be used to provide a signaling frame based packet mapping information for the extended reality in the wireless network.

In the legacy method, a SDU discard procedure involves discard of the PDCP SDU when the associated timer is expired or the successful delivery of a PDCP SDU is confirmed from peer PDCP entity e.g. through a PDCP status report. For XR applications, the existing PDCP SDU discard may not be efficient and effective as the XR applications are more tightly coupled with the frame transmission and not with the IP packet transmission which is typically one to one mapped to PDCP SDU. As a result, existing mechanism may lead to an in-efficient SDU discard operation, excessive processing burden and/or transmission resource wastage and so on. The proposed method provides an enhanced PDCP SDU discard mechanism for the XR. The proposed method provides an efficient and effective PDCP discard operation ensuring timely delivery of packets and saving of transmission resources for XR applications. Thus, the UE and network XR service performance gains significantly with efficient transmission resource usage and lower latency.

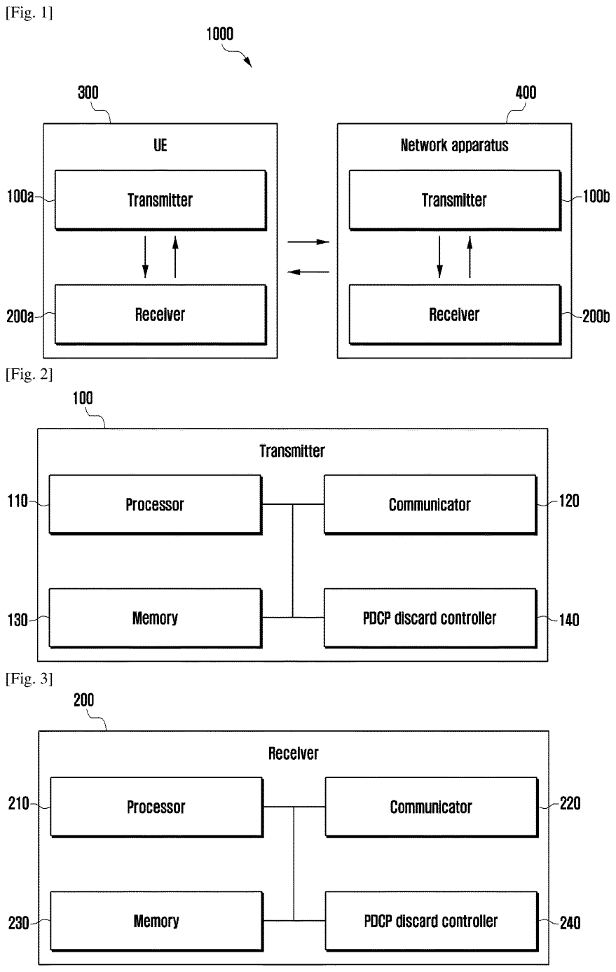

Referring now to the drawings, and more particularly to FIGS. 1 through 14, there are shown preferred embodiments.

FIG. 1 illustrates a wireless network (1000) for discarding PDCP packets for an XR, according to embodiments as disclosed herein. The wireless network (1000) comprises of the UE (300) (e.g., smart phone, immersive device, laptop, IoT device, television, or the like) and a network apparatus (400) each of which may include a transmitter (100a and 100b) (i.e., transmitting PDCP entity) and a receiver (200a and 200b) (i.e., receiving PDCP entity) The PDCP entities in both UE (300) and the network apparatus (400) and there is also bi-directional communication among them. Hereafter, the label of the transmitter is 100 and the label of the receiver is 200.

The transmitter (100) receives a first SDU/PDU of a PDU Set at a PDCP entity from an upper layer of an apparatus (e.g., UE (300) or network apparatus (400) or the like). Upon receiving the first SDU/PDU at the PDCP entity, the transmitter (100) starts a XR discard timer for the PDU Set.

In an embodiment, the transmitter (100) receives a XR radio bearer configuration in the Radio Resource Control (RRC) signaling from a network apparatus (400) (e.g., eNB, gNB or the like). The XR radio bearer configuration includes at least one of an XR discard timer configuration and a PDU Set integrated handling indication (or may be termed as PDU-Set discard indication for the PDCP entity) indicating whether discarding of the PDU Set is allowed at the transmitter (100). Further, the transmitter (100) starts the XR discard timer for the PDU Set upon receiving the first SDU/PDU at the PDCP entity. In another embodiment, the transmitter (100) receives the XR radio bearer configuration from the network apparatus (400). Further, the transmitter (100) starts the XR discard timer for the SDU/PDU of the PDU Set upon receiving the respective SDU/PDU of the PDU Set at the PDCP entity.

Further, the transmitter (100) maps the first SDU/PDU of the PDU Set to the XR discard timer. Further, the transmitter (100) stores the first SDU/PDU of the PDU Set at a PDCP buffer (not shown). Further, the transmitter (100) receives the subsequent SDU/PDU that belongs to the same PDU Set at the PDCP entity from the upper layer of the apparatus. Further, the transmitter (100) detects whether the XR discard timer for the PDU Set is expired.

In an embodiment, the transmitter (100) discards the subsequent SDU/PDU of the PDU Set, when the XR discard timer for the first SDU/PDU of the PDU Set is expired where the subsequent SDU/PDU of the PDU Set is already received at the PDCP entity or discarding is done at the time of receiving the subsequent SDU/PDU of the PDU Set at the PDCP entity. In another embodiment, the transmitter (100) maps the subsequent SDU/PDU of the PDU Set to an XR discard timer per SDU/PDU, when the XR discard timer for the first SDU/PDU of the PDU Set is not expired at the time of receiving the subsequent SDU/PDU of the PDU Set at the PDCP entity. Further, the transmitter (100) stores the subsequent SDU/PDU of the PDU Set at the PDCP buffer.

In an example, the transmitting PDCP entity and/or the receiving PDCP entity catering to an XR service or an XR radio bearer is mapped with XR logical channel(s) (e.g. termed as XR Control Channel, XRCCH and/or XR Traffic Channel, XRTCH). Functionalities of the PDCP entity for the XR (or XR bearer) may be same or different than that for a Dedicated Control Channel (DCCH)/Dedicated Traffic Channel (DTCH) logical channel for unicast. For example, if an XR service is already encrypted, ciphering/deciphering functionality may not be configured for the XR bearer (or a NULL ciphering is configured). Further, the PDCP entity for the XR may be associated with one or more number of Unacknowledged Mode (UM) and/or Acknowledged Mode (AM) RLC entities.

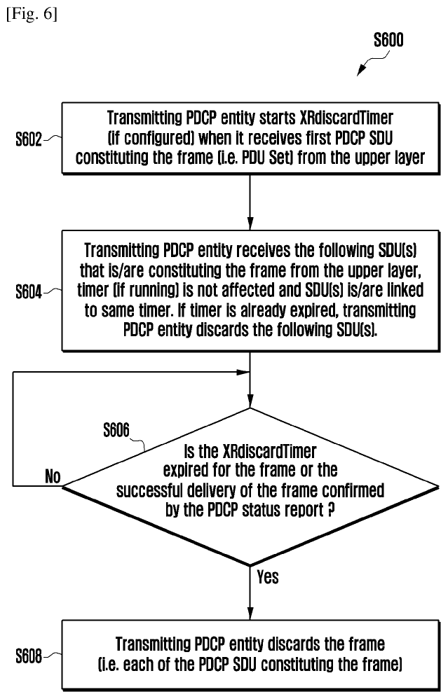

In an embodiment, a timer termed as an XRdiscardTimer is configured for the XR radio bearer (termed as XR-RB) per XR frame (and not per PDCP SDU). That is, the XRdiscardTimer is associated with the XR frame (i.e. PDU Set), and each PDCP SDU of the frame associates to the same XRdiscardTimer. When the XRdiscardTimer expires for the frame or the successful delivery of the frame (that is, successful delivery for each of the PDCP SDU constituting the frame) is confirmed by a PDCP status report, the transmitting PDCP entity may discard the frame (i.e. each of the PDCP SDU constituting the frame or the PDU Set). The same is illustrated in FIG. 6.

In an embodiment, the PDCP entity is configured with multiple discard timer values for different frame types and the transmitting PDCP entity starts the timer with the appropriate discard timer value based on the type of frame the SDU is associated with. For example, frames types (or PDU Sets types) may differ in their priority, importance, QoS parameters, kind of content (e.g. I, P or B frame they pertain) and so on.

In an embodiment, the XRdiscardTimer (if configured) is started when the transmitting PDCP entity receives the first PDCP SDU (i.e. an IP packet) that is constituting the frame or the PDU Set, from the upper layer(s). Further, when the following PDCP SDU(s) that is constituting the frame or the PDU Set (i.e. second SDU, third SDU . . . ) are received, an XRdiscardTimer operation is not affected (i.e. timer keeps running). Further, the following PDCP SDU(s) that is constituting the frame or the PDU Set are linked with the same XRdiscardTimer (if configured).

In an embodiment, if the XRdiscardTimer for the frame or the PDU Set is already expired and subsequently, the transmitting PDCP entity receives further PDCP SDU(s) (i.e. IP packet(s)) from the upper layer, the transmitting PDCP entity discards the received PDCP SDU(s) and doesn't store them in the buffer or transmit them. The following is a sample description of changes introduced to transmit operation at the PDCP entity to support the frame level XR discard timer:

At reception of the PDCP SDU from the upper layers, if the PDCP entity is associated with the XR Bearer, when the PDCP SDU is the first segment associated with a XR frame or PDU Set as indicated by “F” field, the PDCP entity starts the XRdiscardTimer associated with the frame or PDU Set (if configured). Else, the PDCP entity starts the discardTimer associated with the PDCP SDU (if configured).

In an embodiment, the network apparatus (400) configures the XR radio bearer with the XRdiscardTimer through a RRC signaling (e.g. RRC reconfiguration carries the RadioBearerConfig consisting of XRdiscardTimer for a XR RB). Configuration for XRdiscardTimer may be provided instead of legacy discardTimer configuration (used for per SDU discard) or in addition to the discardTimer configuration.

In an embodiment, a legacy discardTimer (used for per SDU discard) when configured for the XR radio bearers acts as XRdiscardTimer. In an embodiment, the legacy discardTimer acts as a frame level discard timer rather than SDU discard timer for XR radio bearers. That is, discardTimer is operated per SDU and the timer is started when a SDU pertaining to the PDU Set is received at PDCP entity from upper layer. When the discardTimer is expired, all the SDUs/PDUs of the PDU Set are discarded to achieve frame level discard.

In an embodiment, when the upper layers request a PDCP SDU discard for the XR (i.e. a frame discard is requested), the transmitting PDCP entity may discard all stored PDCP SDUs and PDCP PDUs pertaining to the frame or PDU Set. In an alternative embodiment, when the upper layers request the PDCP SDU discard for the XR, the transmitting PDCP entity may discard all stored PDCP SDUs and PDCP PDUs.

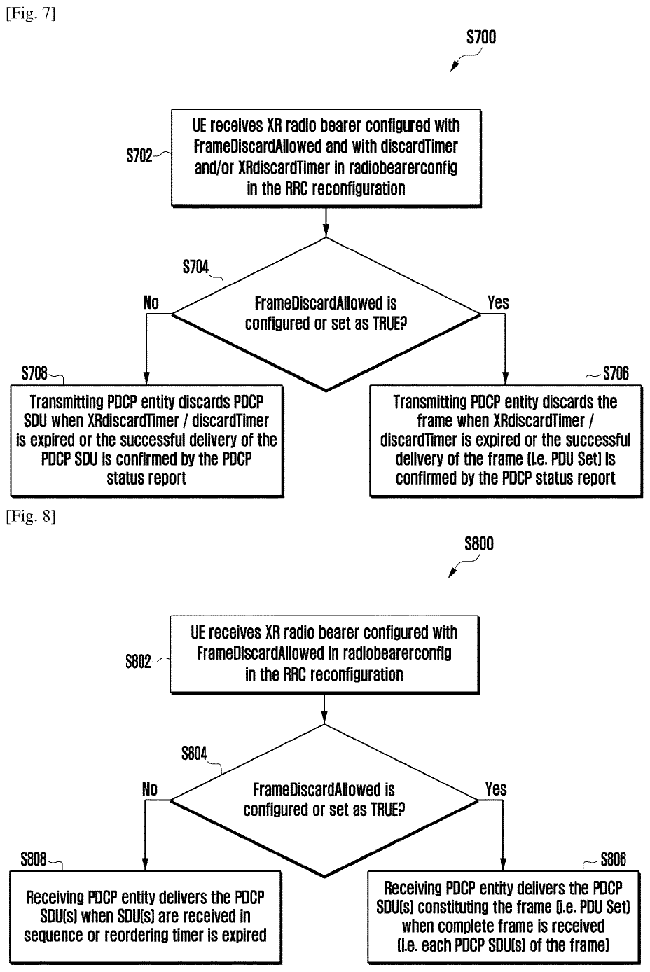

In an embodiment, the UE (300) is configured and/or signaled by the network apparatus (400) for the frame based (i.e. PDU Set based) SDU discard and/or indication whether or not to discard the entire frame if one or more SDUs constituting the frame is discarded (e.g. upon expiry of discardTimer or XRdiscardTimer). The same is illustrated in FIG. 7. Alternatively, the network apparatus (400) may configure a threshold (e.g. number of or percentage of constituent SDUs of the frame, if discarded, will lead the UE (300) to discard the entire frame or the PDU Set).

When one or more PDCP SDU(s) pertaining to the frame (i.e. the PDU Set) which is discarded, are already associated with PDCP sequence number(s) (SN(s)), there may be SN gap in the transmitted PDCP PDUs and the SN gap may cause an increase in PDCP reordering delay in the receiving PDCP entity. In an embodiment, in order to overcome the aforementioned increased reordering delay issue, the UE (300) continues with the already SN assigned PDCP data PDU(s) for the frame but still discard the PDCP SDU(s) for the frame which are not assigned SN. Further, the first PDCP SDU of the next frame is assigned the next in-sequence SN which is yet to be assigned. On the receiving PDCP side, in order to know that there is a discard of PDCP SDUs of a frame and still PDCP SN are in sequence (i.e. without any SN gap), the PDCP header of the first PDCP PDU for the next frame carries an indication field or a bit or a bitmap to indicate an earlier frame discard. The receiving PDCP entity can discard or remove the received PDCP SDUs of the incompletely received XR frame (i.e. PDU Set) and continue processing with the next XR frame. In an embodiment, the number of discarded XR frames can be one or more at the transmitting PDCP entity and correspondingly, at the receiving PDCP entity while reordering.

In an embodiment, upper layers indicate to the PDCP transmitting entity at least one of the start of the XR frame (i.e. PDU Set) with the provided first PDCP SDU or IP packet, the end of the XR frame with the provided last PCP SDU or IP packet, size of the frame (or number of constituent SDUs, number of bytes), sequence number, priority and QoS info of the frame (i.e. PDU Set). The PDCP entity does book-keeping (e.g. maintain one or more variables) to track the XR frame start and/or frame end mapping with the corresponding PDCP SDU(s).

In an embodiment, all the PDCP SDU(s) pertaining to the frame (i.e. PDU Set) are assigned the same sequence number value. The transmitting side RLC entity indicates successful transmission of SDUs only after all the SDU(s) are delivered successfully.

In an embodiment, in addition to PDCP SN, the sequence number (i.e. the position) of the SDU in the frame (i.e. a sub sequence number-SSN for the SDU to indicate its position in the frame) is also transmitted by the transmitting PDCP entity. The last SDU in the frame (i.e. PDU Set) may have a special value to indicate the end of frame. In an embodiment, an end marker may be provided along with the position for the last SDU in the frame.

In an embodiment, the receiving PDCP entity performs reordering of the SDUs belonging to same frame (i.e. PDU Set) using the SSN for the SDUs in the frame.

In an embodiment, the receiving PDCP entity also may be configured with the discard timer (frame level discard timer) and on expiry of the said timer, the receiving PDCP entity discards all the SDUs in the frame (i.e. PDU Set).

In an embodiment, the receiving PDCP entity may be configured with a frame level reordering timer and on the expiry of frame level reordering timer, all the SDUs belonging to the frame (i.e. PDU Set) are either discarded or delivered to the upper layer.

In an embodiment, the receiving PDCP entity may be configured with the frame level indication for whether in sequence delivery is needed or not, i.e. receiving PDCP entity may be configured with frameleveloutoforder delivery separately from legacy (SDU level) outoforderdelivery in the current NR system.

In an embodiment, the receiving PDCP entity may be configured to deliver to upper layer without waiting for reordering timer to expire, if all SDUs associated with a frame (i.e. PDU Set) are received in a PDCP reception buffer.

In another embodiment, the receiving PDCP entity may be configured to deliver to upper layer the SDUs pertaining to frame (i.e. PDU Set) only when all SDUs associated with that frame are received, so as to provide a frame level delivery instead of the legacy SDU level delivery mechanism.

In an embodiment, the frame information (e.g. start SDU, end SDU, number of SDUs, SDU sequence number, frame type like I-frame (Intra-coded frame)/P-frame (Predicted frame)/B-frame (Bidirectional predicted frame) etc., priority, importance, QoS info) are provided embedded in the packet or packet header, where I frames holds complete frame, P frames holds only change from the previous frame, and B frames holds differences between the current frame and both the preceding and following frames to specify its content. That is, frame (i.e. PDU Set) information is marked/signaled in the header of the upper layer packet received (e.g. IP packet, RTP/SRTP/TCP/UDP packet etc.). The same is applicable to the UE (300) and/or the network apparatus (400).

In an embodiment, the transmitting PDCP entity sets a field or a bit or a bitmap (e.g. in the PDCP header) to indicate the start of the XR frame (i.e. PDU Set) in the PDCP SDU which is the first PDCP SDU carrying the XR frame. In an alternative embodiment, the transmitting PDCP entity sets a field or the bit or the bitmap (e.g. in the PDCP header) to indicate the end of the XR frame in the PDCP SDU which is the last PDCP SDU carrying the XR frame. Further, the field can also include indication for the continuation for the frame in the header pertaining to the received PDCP SDU. For example, a field or a bitmap termed as “F” is set to 00 indicate a continuing frame in current SDU (i.e. in-between SDU), set to 01 indicate start of frame in the current SDU and continuing in the next SDU, set to 10 may indicate continuing from previous SDU and end of the frame in the current SDU, and set to 11 may indicate both start and end of frame in the current SDU (i.e. only one SDU forms the frame).

In an embodiment, the receiving PDCP entity while processing in-sequence received PDCP PDU(s) determines for received frame incompletion (e.g. a new frame starts in current SN PDCP PDU from the F field in the PDCP header but the end of last frame was not indicated by the F field in the PDCP header in the immediately previous SN PDCP PDU). The receiving PDCP entity can discard or remove the received PDCP SDUs of the incompletely received XR frame (i.e. PDU Set) and continue processing with the next XR frame.

In an embodiment, discard or removal of incompletely received XR frame (i.e. PDU Set) is handled by the upper layer(s) and not by the PDCP entity. That is, the PDCP entity still delivers the PDCP SDU(s) pertaining to the incompletely received XR frame to the upper layer(s). Further, additionally, the PDCP may indicate the indication for an incompletely received frame to the upper layer(s).

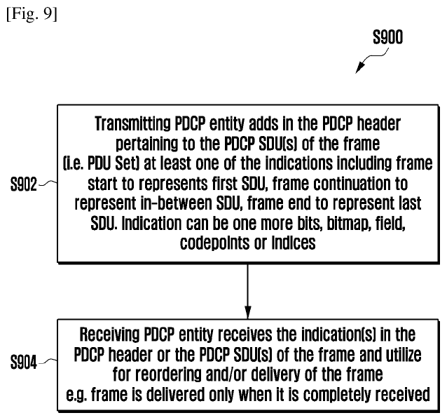

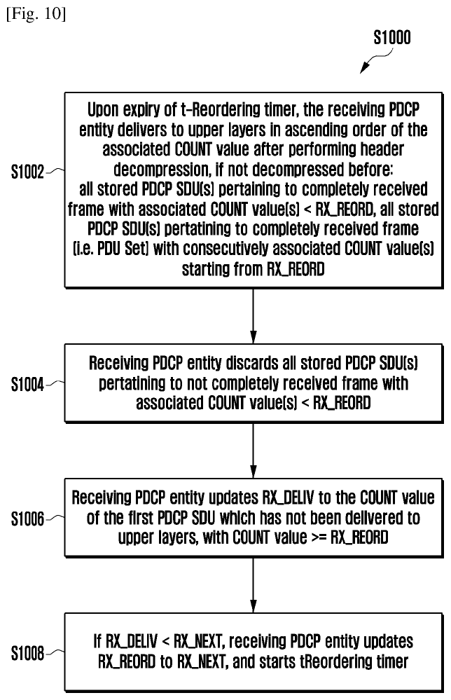

Further, when receiving PDCP entity receives the field or bit or bitmap in the PDCP SDU indicating start (and/or end) of the XR frame (i.e. PDU Set), it utilizes the information for the reordering and/or delivery of the XR frame or the constituent PDCP SDUs to the upper layers (the same is also illustrated in FIG. 9). For example, when reordering timer t-Reordering expires, the operation of receiving PDCP entity is described as below (the same is also illustrated in FIG. 10).

When t-Reordering expires, the receiving PDCP entity shall:
Deliver to the upper layers in an ascending order of the associated COUNT value after performing header decompression, if not decompressed before:
all stored PDCP SDU(s) pertaining to completely received frame with associated COUNT value(s)<RX_REORD;
all stored PDCP SDU(s) pertaining to completely received frame with consecutively associated COUNT value(s) starting from RX_REORD;
Discard all stored PDCP SDU(s) pertaining to not completely received frame with associated COUNT value(s)<RX_REORD;
Update RX_DELIV to the COUNT value of the first PDCP SDU which has not been delivered to upper layers, with COUNT value>=RX_REORD;
   if RX_DELIV<RX_NEXT:
   update RX_REORD to RX_NEXT;
   start t-Reordering.

In an embodiment, a PDCP duplication is employed for the XR. Further, the PDCP duplication is configured and/or utilized selectively for the one or more XR flows/sub-flows/bearers or PDU Sets or frame types (e.g. I/P/B frames) pertaining to the same XR service. Further, for XR RBs, transmitting PDCP entity, when configured (or de-configured) with pdcp-duplication, activates (or deactivates) the PDCP duplication for XR RB from the first PDCP SDU of the XR frame. In an embodiment, the PDCP can be configured with types of frames for which the selective duplications is applied for. The following is a sample description of changes introduced in PDCP transmit entity operation to support selective duplication:

When submitting a PDCP PDU to a lower layer, the transmitting PDCP entity shall:
if the transmitting PDCP entity is associated with one RLC entity:
submit the PDCP PDU to the associated RLC entity;
else, if the transmitting PDCP entity is associated with at least two RLC entities:
if the PDCP duplication is activated for the RB:
if the PDCP PDU is a PDCP Data PDU:
if PDCP entity is associated with a XR Bearer and selective duplication is configured:
if the PDCP Data PDU corresponds to a frame type configured for duplication:
duplicate the PDCP Data PDU and submit the PDCP Data PDU to the associated RLC entities activated for PDCP duplication;
else
duplicate the PDCP Data PDU and submit the PDCP Data PDU to the associated RLC entities activated for PDCP duplication;
else:
submit the PDCP Control PDU to the primary RLC entity;

In an embodiment, when the upper layer request a PDCP entity re-establishment, for AM DRBs for an Uu interface for the XR whose PDCP entities were suspended, from the first PDCP SDU for which the successful delivery of the corresponding PDCP Data PDU has not been confirmed by lower layers, for each PDCP SDU already associated with the PDCP SN, the transmitting PDCP entity for the XR performs transmission of the PDCP SDUs in ascending order of the COUNT value associated to the PDCP XR frame (i.e. PDU Set) prior to the PDCP re-establishment without restarting the XRdiscardTimer.

In an embodiment, when the upper layer requests the PDCP entity re-establishment, if XRdiscardTimer is still running, for AM DRBs for the Uu interface for XR whose PDCP entities were suspended, from the first PDCP SDU for which the successful delivery of the corresponding PDCP Data PDU has not been confirmed by lower layers, for each PDCP SDU already associated with a PDCP SN, the transmitting PDCP entity for XR performs transmission of the PDCP SDUs in ascending order of the COUNT value associated to the PDCP XR frame (i.e. PDU Set) prior to the PDCP re-establishment without restarting the XRdiscardTimer. If XRdiscardTimeris expired, the transmitting PDCP entity for XR does not perform transmission of the PDCP SDUs.

In an embodiment, when the upper layer requests the PDCP entity re-establishment, for AM DRBs for XR whose PDCP entities were not suspended, from the first PDCP SDU for which the successful delivery of the corresponding PDCP Data PDU has not been confirmed by lower layers, the transmitting PDCP entity for XR perform retransmission or transmission of all the PDCP SDUs already associated with PDCP SNs in ascending order of the COUNT values associated to the PDCP SDU prior to the PDCP entity re-establishment, provided XRdiscardTimer is still running.

In an embodiment, when the upper layer request a PDCP entity re-establishment, the receiving PDCP entity for XR UM mode radio bearers stops and resets the t-Reordering timer, if running. Further, the receiving PDCP entity delivers all stored PDCP SDU(s) to the upper layers in ascending order of associated COUNT values after performing header decompression (if configured).

In an embodiment, when the upper layer request a PDCP entity re-establishment, the receiving PDCP entity for XR UM mode radio bearers stops and resets the t-Reordering timer, if running. Further, it delivers only those stored PDCP SDU(s) that form complete XR frames(s) (i.e. PDU Sets) to the upper layers in ascending order of associated COUNT values after performing header decompression (if configured).

In an embodiment, when upper layers request a PDCP entity release for a XR radio bearer, the UE (300) may discard all stored PDCP SDUs and PDCP PDUs in the transmitting PDCP entity. Further, for XR radio bearer(s), the UE (300) may deliver the PDCP SDUs stored in the receiving PDCP entity to upper layers in ascending order of associated COUNT values after performing header decompression, if configured and not decompressed before, provided all the constituent SDUs of the XR frame (i.e. PDU Set) are received. Further, the UE (300) may release the PDCP entity for the XR radio bearer.

In an embodiment, when the upper layers request a PDCP entity suspend, if t-Reordering is running, the receiving PDCP entity stops and resets t-Reordering. Further, it delivers all stored PDCP SDUs to the upper layers in ascending order of associated COUNT values after performing header decompression, provided all the constituent SDUs of the XR frame (i.e. PDU Set) are received. Further, it sets RX_NEXT and RX_DELIV to the initial value.

In an embodiment, when the upper layer reconfigure the PDCP entity to configure Dual Active Protocol Stack (DAPS) and/or release DAPS, the timer XRdiscardTimer is continued i.e. timer is kept running during PDCP entity reconfiguration procedure.

In an embodiment, a procedure for managing received PDCP data PDU at the receiving PDCP entity for XR radio bearer is described as below (the same is illustrated in FIG. 3).

If the received PDCP Data PDU with COUNT value=RCVD_COUNT and is not discarded (e.g. integrity failure, duplicate), the receiving PDCP entity shall:
Store the resulting PDCP SDU in the reception buffer;
If RCVD_COUNT>=RX_NEXT:
   update RX_NEXT to RCVD_COUNT+1.

If frameoutOfOrderDelivery is configured:
if all byte segments for the corresponding frame is received in reception buffer, consider the frame to be fully received:
deliver all the PDCP SDU(s) associated with the complete frame to upper layer after performing header decompression.
update RX_DELIV to the COUNT value of the first PDCP SDU which has not been delivered to upper layers, with COUNT value>RX_DELIV;

Else, if outofOrderDelivery is configured:
deliver the resulting PDCP SDU to upper layers after performing header decompression using EHC (if configured).

If RCVD_COUNT=RX_DELIV:
deliver to upper layers in ascending order of the associated COUNT value after performing header decompression (if configured), if not decompressed before;
all stored PDCP SDU(s) with consecutively associated COUNT value(s) starting from COUNT=RX_DELIV, provided they pertain to completely received frame if frameDelivery Allowed is configured and/or set as TRUE; or
all stored PDCP SDU(s) with consecutively associated COUNT value(s) starting from COUNT=RX_DELIV, if frameDelivery Allowed is not configured and/or set as FALSE;
update RX_DELIV to the COUNT value of the first PDCP SDU which has not been delivered to upper layers, with COUNT value>RX_DELIV;
If t-Reordering is running, and if RX_DELIV>=RX_REORD:
stop and reset t-Reordering.

If t-Reordering is not running (includes the case when t-Reordering is stopped due to actions above), and RX_DELIV<RX_NEXT:
update RX_REORD to RX_NEXT;
start t-Reordering.

In an embodiment, the configurations for XR bearers are carried in RRCReconfiguration message as part of PDCP configuration or separately as part of XRBearerConfigurations.

The following is the sample ASN structure of PDCPConfig containing XR Bearer related PDCP layer configurations:

| | |
|---|---|
| PDCP-Config ::= | SEQUENCE { |
| drb | SEQUENCE { |
| discardTimer | ENUMERATED {ms10, ms20, ms30, ms40, ms50, |

ms60, ms75, ms100, ms150, ms200,

| | |
|---|---|
| | ms250, ms300, ms500, |
| ms750, ms1500, infinity} | OPTIONAL, -- Cond Setup |
| XRdiscardTimer | ENUMERATED {ms0dot5, ms1, ms2, ms4, ms6, |

```
  ms8, ms10, ms20, ms30, ms40, ms50, ms60, ms75, ms100, ms150, ms200,ms250,
  ms300, ms500, ms750, ms1500, infinity} OPTIONAL, -- Cond Setup
```

| | |
|---|---|
| pdcp-SN-SizeUL | ENUMERATED {len12bits, len18bits} |

OPTIONAL, -- Cond Setup1

| | |
|---|---|
| pdcp-SN-SizeDL | ENUMERATED {len12bits, lens18bits} |

OPTIONAL, -- Cond Setup2

| | |
|---|---|
| headerCompression | CHOICE { |
| notUsed | NULL, |
| rohc | SEQUENCE { |
| maxCID | INTEGER (1..16383) |

DEFAULT 15,

| | |
|---|---|
| profiles | SEQUENCE { |
| profile0x0001 | BOOLEAN, |
| profile0x0002 | BOOLEAN, |
| profile0x0003 | BOOLEAN, |
| profile0x0004 | BOOLEAN, |
| profile0x0006 | BOOLEAN, |
| profile0x0101 | BOOLEAN, |
| profile0x0102 | BOOLEAN, |
| profile0x0103 | BOOLEAN, |
| profile0x0104 | BOOLEAN |

},

```
          |drb-ContinueROHC ENUMERATED { true }
    OPTIONAL -- Need N
```

},

uplinkOnlyROHC SEQUENCE {

| | |
|---|---|
| maxCID | INTEGER (1..16383) |

DEFAULT 15,

| | |
|---|---|
| profiles | SEQUENCE { |
| profile0x0006 | BOOLEAN |

},

```
      drb-ContinueROHC ENUMERATED { true }
OPTIONAL -- Need N
                },
                ...
              },
      integrityProtection ENUMERATED { enabled }
OPTIONAL, -- Cond ConnectedTo5GC1
      statusReportRequired ENUMERATED { true }
OPTIONAL, -- Cond Rlc-AM-UM
      outOfOrderDelivery ENUMERATED { true }
OPTIONAL -- Need R
      }
OPTIONAL, -- Cond DRB
```

| | |
|---|---|
| t-ReorderingXR | ENUMERATED { |
| | {ms0, ms1, ms2, ms4, ms5, ms8, |

```
ms10, ms15, ms20, ms30, ms40,ms50, ms60, ms80, ms100, ms120, ms140, ms160,
ms180, ms200, ms220,ms240, ms260, ms280, ms300, ms500, ms750, ms1000,
ms1250,ms1500, ms1750, ms2000, ms2250, ms2500, ms2750,ms3000, spare28,
spare27, spare26, spare25, spare24,spare23, spare22, spare21, spare20,
spare19, spare18, spare17, spare16, spare15, spare14, spare13, spare12,
spare11, spare10, spare09, spare08, spare07, spare06, spare05, spare04,
spare03, spare02, spare01 }
OPTIONAL, -- Need S
        <<Unchanged Text omitted>>
            [[
            survivalTimeStateSupport-r17 ENUMERATED {true}
OPTIONAL, -- Cond Drb-Duplication
            uplinkDataCompression-r17 SetupRelease
{ UplinkDataCompression-r17 } OPTIONAL, -- Cond Rlc-AM
            discardTimerExt2-r17 SetupRelease { DiscardTimerExt2-
```

| | |
|---|---|
| r17 } | OPTIONAL, -- Need N |

```
            multicastHFN-AndRefSN-r17 BIT STRING (SIZE (32))
  OPTIONAL -- Cond SetupOnlyMRB
            ]],
        [[
        isXRBearer ENUMERATED {true} OPTIONAL,
        frameDiscardAllowed ENUMERATED {true} OPTIONAL,
        frameOutOfOrderDelivery ENUMERATED {true} OPTIONAL,
        frameDeliveryAllowedENUMERATED {true} OPTIONAL,
        useSSNperFrame ENUMERATED {true} OPTIONAL,
        selectiveDuplicationSuppport ENUMERATED {true} OPTIONAL,
        ]]
        }
```

Field Descriptions are as shown in table-1:

### Field Descriptions

isXRBearer The isXRBearer field indicates if the PDCP entity belongs to a XR Radio bearer. The isXRBearer field is set when a XR bearer is being setup.

XRdiscardTimer The XRdiscardTimer indicates the value in ms of XRdiscardTimer that is used for XR, if configured.

t-ReorderingXR The t-ReorderingXR field indicates the value in ms of t-Reordering XR that is used for XR for frame level reordering, if configured

frameDiscardAllowed If included, the field indicates that the PDCP performs frame level discard (i.e. PDU Set based discard) in the transmitter side if one or more constituent PDCP SDU(s) of the frame (i.e. PDU Set) is discarded.

frameOutOfOrderDelivery If included, the field indicates if the PDCP receive entity delivers the SDUs of a received frame(s) out of order with respect to frame number.

frameDelivery Allowed The frameDelivery Allowed field indicates that the PDCP receiver delivers to upper layer the received SDUs at frame level by waiting till all SDUs of the frame (i.e. PDU Set) are received.

useSSNperFrame The useSSNperFrame field indicates that PDCP uses sub-sequence number (SSN) to indicate the position of an SDU within a frame. When configured, all SDUs of a single frame will be assigned same SN and individually identified based on SSN

selectiveDuplicationSupp-ort If configured, when the PDCP duplication is enabled and activated, the PDCP performs duplication for configured high priority frame PDUs only.

### Table-1

FIG. 2 shows various hardware components of the transmitter (100), according to the embodiments as disclosed herein. In an embodiment, the transmitter (100) includes a processor (110), a communicator (120), a memory (130) and a PDCP discard controller (140). The processor (110) is coupled with the communicator (120), the memory (130) and the PDCP discard controller (140).

The PDCP discard controller (140) receives the first SDU/PDU of the PDU Set at the PDCP entity from the upper layer entity of the apparatus. Upon receiving the first SDU/PDU at the PDCP entity, the PDCP discard controller (140) starts the XR discard timer for the PDU Set.

In an embodiment, the PDCP discard controller (140) receives the XR radio bearer configuration in the Radio Resource Control (RRC) signaling from the network apparatus (400). The XR radio bearer configuration includes at least one of the XR discard timer configuration and the PDU Set integrated handling indication (or may be termed as PDU-Set discard indication for the PDCP entity) indicating whether discarding of the PDU Set is allowed at the transmitter (100). Further, the PDCP discard controller (140) starts the XR discard timer for the PDU Set upon receiving the first SDU/PDU at the PDCP entity. In another embodiment, the PDCP discard controller (140) receives the XR radio bearer configuration from the network apparatus (400). Further, the PDCP discard controller (140) starts the XR discard timer for the SDU/PDU of the PDU Set upon receiving the respective SDU/PDU of the PDU Set at the PDCP entity.

Further, the PDCP discard controller (140) maps the first SDU/PDU of the PDU Set to the XR discard timer. Further, the PDCP discard controller (140) stores the first SDU/PDU of the PDU Set at the PDCP buffer. Further, the PDCP discard controller (140) receives the subsequent SDU/PDU that belongs to the same PDU Set at the PDCP entity from the upper layer entity of the apparatus.

Further, the PDCP discard controller (140) detects whether the XR discard timer for the PDU Set is expired.

In an embodiment, the PDCP discard controller (140) discards the subsequent SDU/PDU of the PDU Set, when the XR discard timer for the first SDU/PDU of the PDU Set is expired where the subsequent SDU/PDU of the PDU Set is already received at the PDCP entity or discarding is done at the time of receiving the at least one subsequent SDU/PDU of the PDU Set at the PDCP entity. In another embodiment, the PDCP discard controller (140) maps the subsequent SDU/PDU of the PDU Set to an XR discard timer per SDU/PDU, when the XR discard timer for the first SDU/PDU of the PDU Set is not expired at the time of receiving the subsequent SDU/PDU of the PDU Set at the PDCP entity. Further, the PDCP discard controller (140) stores the subsequent SDU/PDU of the PDU Set at the PDCP buffer.

Further, the PDCP discard controller (140) detects that the XR discard timer for the PDU Set is expired or loss of at least one SDU/PDU constituting the PDU Set or a successful delivery of all SDU/PDU constituting the PDU Set. Further, the PDCP discard controller (140) discards the PDU Set comprising the first SDU/PDU and the subsequent SDU/PDU mapped to the XR discard timer for the PDU Set, when the XR discard timer for the PDU Set is expired or loss of at least one SDU/PDU constituting the PDU Set is detected or the successful delivery of all SDU/PDU constituting the PDU Set is detected.

Further, the PDCP discard controller (140) detects that the XR discard timer for the at least one SDU/PDU of the PDU Set is expired or loss of at least one SDU/PDU constituting the PDU Set or a successful delivery of all SDU/PDU constituting the PDU Set. Further, the PDCP discard controller (140) discards the PDU Set comprising the first SDU/PDU and the subsequent SDU/PDU for the PDU Set, when the XR discard timer for the at least one SDU/PDU of the PDU Set is expired or loss of at least one SDU/PDU constituting the PDU Set is detected or a successful delivery of all SDU/PDU constituting the PDU Set is detected.

Further, the PDCP discard controller (140) adds, in the PDCP header in each SDU/PDU at least one of a frame start indication representing the first SDU/PDU of the PDU Set, frame continuation indication representing the subsequent SDU/PDU of the PDU Set, and a frame end indication representing the last SDU/PDU of the PDU Set. Further, the PDCP discard controller (140) sends at least one of the first SDU/PDU and the subsequent SDU/PDU belonging to the same PDU Set to the receiver (200).

The first SDU/PDU and the subsequent SDU/PDU of the PDU Set is discarded by detecting whether the PDU Set integrated handling indication indicates that the discarding of the PDU Set is allowed at the transmitter (100) and one of discarding the first SDU/PDU and the subsequent SDU/PDU of the PDU Set when the PDU Set integrated handling indication indicates that the discarding of the PDU Set is allowed at the transmitter (100) or discarding the respective SDU/PDU when the PDU Set integrated handling indication indicates that the discarding of the PDU Set is not allowed at the transmitter (100).

The PDCP discard controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2 shows various hardware components of the transmitter (100) but it is to be understood that other embodiments are not limited thereon. In other embodiments, the transmitter (100) may include less or more number of components. Further, the labels or names of the components are used only for illustrative purpose and does not limit the scope of the invention. One or more components can be combined together to perform same or substantially similar function in the transmitter (100).

FIG. 3 shows various hardware components of the receiver (200), according to the embodiments as disclosed herein. In an embodiment, the receiver (200) includes a processor (210), a communicator (220), a memory (230) and a PDCP discard controller (240). The processor (210) is coupled with the communicator (220), the memory (230) and the PDCP discard controller (240).

The PDCP discard controller (240) receives the XR radio bearer configuration in the Radio Resource Control (RRC) signaling from the network apparatus (400). The XR radio bearer configuration includes the frame delivery allowed indication indicating whether the completely received PDU Set is allowed to be delivered from the receiver (200) is configured. Further, the PDCP discard controller (240) receives the plurality of SDU/PDU that belongs to the PDU Set, where the PDCP header in each of the SDU/PDU comprises the frame start indication representing the first SDU/PDU of the PDU Set, the frame continuation indication representing the subsequent SDU/PDU of the PDU Set, and the frame end indication representing the last SDU/PDU of the PDU Set. Further, the PDCP discard controller (240) detects whether the frame delivery allowed indication indicates the PDU/SDU is allowed to be delivered from the receiver (200) is configured.

In an embodiment, the PDCP discard controller (240) delivers the plurality of SDU/PDU that belongs to the PDU Set to the upper layer entity after the complete PDU Set is received when the frame delivery allowed indication indicates the completely received PDU Set is allowed to be delivered from the receiver (200) is configured.

In another embodiment, the PDCP discard controller (240) reorders the plurality of SDU/PDU that belongs to the PDU Set based on the PDCP header of the SDU/PDU when the frame delivery allowed indication indicates a completely received PDU Set is allowed to be delivered from the receiver (200) is not configured. Further, the PDCP discard controller (240) delivers each SDU/PDU of the plurality of SDU/PDU that belongs to the PDU Set to the upper layer entity based on the reordering timer expiry.

In an embodiment, the PDCP discard controller (240) decompresses the PDCP header based on at least one of all stored SDU/PDU pertaining to completely received PDU Set with associated COUNT value less than RX_REORD, and all stored SDU/PDU pertaining to completely received PDU Set with associated COUNT value starting from RX_REORD. The RX_REORD indicates the COUNT value following the COUNT value associated with the PDCP Data PDU which triggered reordering timer. Further, the PDCP discard controller (240) discards all the stored SDU/PDU pertaining to not completely received PDU Set with associated COUNT value(s) less than RX_REORD. Further, the PDCP discard controller (240) delivers each SDU/PDU of the plurality of SDU/PDU that belongs to the completely received PDU Set in ascending order of the associated COUNT value to the upper layer entity. Further, the PDCP discard controller (240) updates RX_DELIV to the COUNT value of the first SDU/PDU which has not been delivered to upper layers, with COUNT value greater than or equal to RX_REORD, wherein the RX_DELIV indicates the COUNT value of the first PDCP SDU not delivered to the upper layers. Further, the PDCP discard controller (240) updates RX_REORD to RX_NEXT and starting a reordering timer, if RX_DELIV is less than RX_NEXT, wherein the RX_NEXT indicates the COUNT value of the next PDCP SDU expected to be received.

The PDCP discard controller (240) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include nonvolatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 3 shows various hardware components of the receiver (200) but it is to be understood that other embodiments are not limited thereon. In other embodiments, the receiver (200) may include less or more number of components. Further, the labels or names of the components are used only for illustrative purpose and does not limit the scope of the invention. One or more components can be combined together to perform same or substantially similar function in the receiver (200).

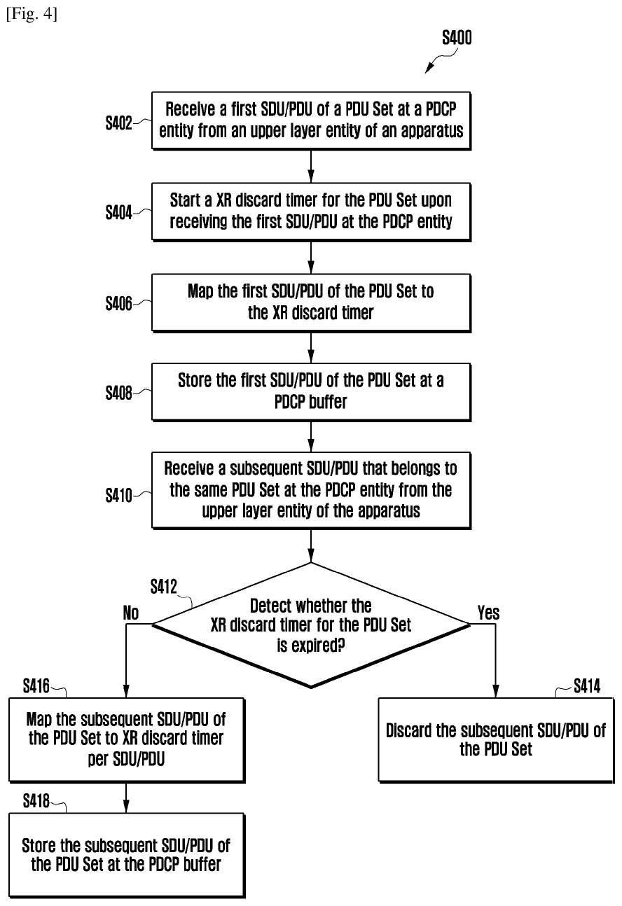

FIG. 4 is a flow chart (S400) illustrating a method, implemented by the transmitter (100), for discarding the PDCP packets for the XR in the wireless network (1000), according to embodiments as disclosed herein. The operations (S402-S418) are handled by the PDCP discard controller (140).

At S402, the method includes receiving the first SDU/PDU of the PDU Set at the PDCP entity from the upper layer entity of the apparatus. At S404, the method includes starting the XR discard timer for the PDU Set upon receiving the first SDU/PDU at the PDCP entity. At S406, the method includes mapping the first SDU/PDU of the PDU Set to the XR discard timer. At S408, the method includes storing the first SDU/PDU of the PDU Set at the PDCP buffer. At S410, the method includes receiving the subsequent SDU/PDU that belongs to the same PDU Set at the PDCP entity from the upper layer entity of the apparatus. At S412, the method includes detecting whether the XR discard timer for the PDU Set is expired.

In an embodiment, At S414, the method includes discarding the subsequent SDU/PDU of the PDU Set, when the XR discard timer for the first SDU/PDU of the PDU Set is expired wherein at least one subsequent SDU/PDU of the PDU Set is already received at the PDCP entity or discarding is done at the time of receiving the at least one subsequent SDU/PDU of the PDU Set at the PDCP entity. In another embodiment, At S416, the method includes mapping the subsequent SDU/PDU of the PDU Set to the XR discard timer per SDU/PDU, when the XR discard timer for the first SDU/PDU of the PDU Set is not expired at the time of receiving the subsequent SDU/PDU of the PDU Set at the PDCP entity. At S418, the method includes storing the subsequent SDU/PDU of the PDU Set at the PDCP buffer.

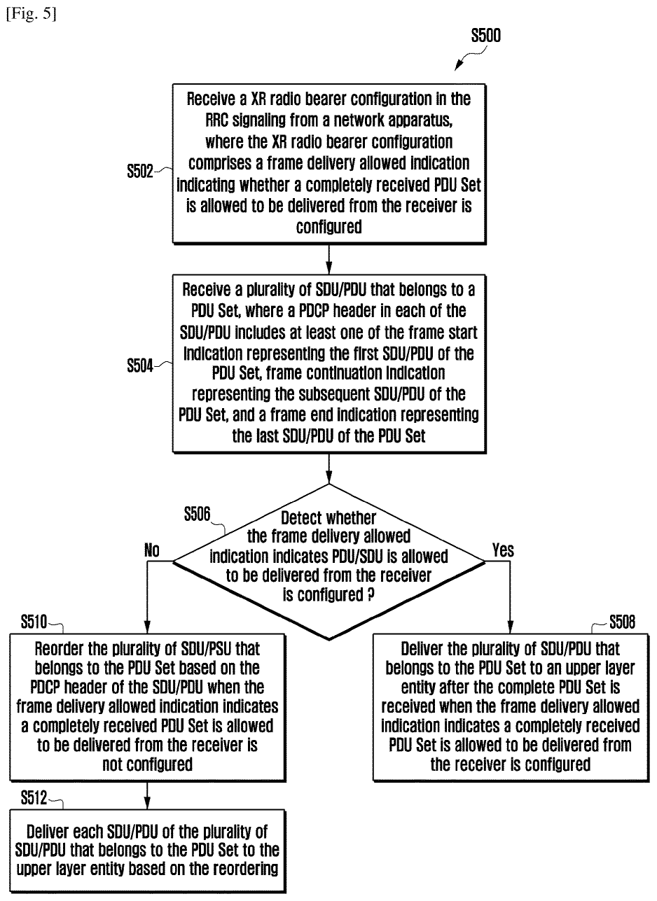

FIG. 5 is a flow chart (S500) illustrating a method, implemented by the receiver (200), for discarding the PDCP packets for the XR in the wireless network (1000), according to embodiments as disclosed herein. The operations (S502-S512) are handled by the PDCP discard controller (240).

At S502, the method includes receiving the XR radio bearer configuration in the Radio Resource Control (RRC) signaling from the network apparatus (400). The XR radio bearer configuration includes the frame delivery allowed indication indicating whether the completely received PDU Set is allowed to be delivered from the receiver is configured. At S504, the method includes receiving the plurality of SDU/PDU that belongs to the PDU Set, where the PDCP header in each of the SDU/PDU includes at least one of the frame start indication representing the first SDU/PDU of the PDU Set, the frame continuation indication representing the subsequent SDU/PDU of the PDU Set, and the frame end indication representing the last SDU/PDU of the PDU Set. At S506, the method includes detecting whether the frame delivery allowed indication indicates PDU/SDU is allowed to be delivered from the receiver (200) is configured. In an embodiment, At S508, the method includes delivering the plurality of SDU/PDU that belongs to the PDU Set to the upper layer entity after the complete PDU Set is received when the frame delivery allowed indication indicates the completely received PDU Set is allowed to be delivered from the receiver (200) is configured. In another embodiment, at S510, the method includes reordering the plurality of SDU/PDU that belongs to the PDU Set based on the PDCP header of the SDU/PDU when the frame delivery allowed indication indicates the completely received PDU Set is allowed to be delivered from the receiver is not configured. At S512, the method includes delivering each SDU/PDU of the plurality of SDU/PDU that belongs to the PDU Set to the upper layer entity based on the reordering.

FIG. 6 is a flow chart (S600) illustrating a PDCP discard mechanism at a transmitting PDCP entity for the XR in the wireless network (1000), according to embodiments as disclosed herein. The operations (S602-S608) are handled with the assistance of the PDCP discard controller (140).

At S602, the transmitting PDCP entity starts the XRdiscardTimer (if configured) when the transmitting PDCP entity receives the first PDCP SDU constituting the frame (i.e. PDU Set) from the upper layer. At S604, the transmitting PDCP entity receives the following SDU(s) that is/are constituting the frame from the upper layer, the timer (if running) is not affected and the SDU(s) is/are linked to same timer. If the timer is already expired, the transmitting PDCP entity discards the following SDU(s). At S606, the method includes determining whether the XRdiscardTimer is expired for the frame or the successful delivery of the frame confirmed by the PDCP status report?

In response to determining that the XRdiscardTimer is expired for the frame or the successful delivery of the frame confirmed by the PDCP status report then, at S608, the transmitting PDCP entity discards the frame (i.e. each of the PDCP SDU constituting the frame i.e. PDU Set). In response to determining that the XRdiscardTimer is not expired for the frame or the successful delivery of the frame is confirmed by the PDCP status report then, the method performs the operations S606.

FIG. 7 is a flow chart (S700) illustrating a PDCP discard mechanism at the transmitting PDCP entity for the XR based on the configuration parameter in the wireless network (1000), according to embodiments as disclosed herein. The operations (S702-S708) are handled with the assistance of the PDCP discard controller (140).

At S702, the UE (300) receives the XR radio bearer configured with the FrameDiscardAllowed and with the discardTimer and/or the XRdiscardTimer in the radiobearerconfig in the RRC reconfiguration. At S704, the method includes determining whether the FrameDiscardAllowed is configured or set as TRUE?

In response to determining that the FrameDiscardAllowed is configured or set as TRUE then, at S706, the transmitting PDCP entity discards the frame (i.e. PDU Set) when the XRdiscardTimer/discardTimer is expired or the successful delivery of the frame is confirmed by the PDCP status report. In response to determining that the FrameDiscardAllowed is not configured or set as FALSE then, at S708, the transmitting PDCP entity discards the PDCP SDU when XRdiscardTimer/discardTimer is expired or the successful delivery of the PDCP SDU is confirmed by the PDCP status report.

FIG. 8 is a flow chart (S800) illustrating a PDCP reordering and delivery mechanism at a receiving PDCP entity (i.e., receiver (200)) for the XR in the wireless network (1000), according to embodiments as disclosed herein. The operations (S802-S808) are handled with the assistance of the PDCP discard controller (240).

At S802, the UE (300) receives the XR radio bearer configured with the FrameDelivery Allowed in the radiobearerconfig in the RRC reconfiguration. At S804, the UE (300) determines whether the FrameDeliveryAllowed is configured or set as TRUE?

In response to determining that the FrameDeliveryAllowed is configured or set as TRUE then, at S806, the receiving PDCP entity delivers the PDCP SDU(s) constituting the frame (i.e. PDU Set) when complete frame is received (i.e. each PDCP SDU(s) of the frame). In response to determining that the FrameDelivery Allowed is not configured or set as FALSE then, at S808, the receiving PDCP entity delivers the PDCP SDU(s) when the SDU(s) are received in sequence or the reordering timer is expired.

FIG. 9 is a flow chart (S900) illustrating a method for conveying frame-PDCP SDU mapping information for the XR in the wireless network (1000), according to embodiments as disclosed herein.

At S902, the transmitting PDCP entity adds in the PDCP header pertaining to the PDCP SDU(s) of the frame (i.e. PDU Set) at least one of the indications including frame start to represents first SDU, the frame continuation to represent in-between SDU, the frame end to represent last SDU. The indication can be one more bits, bitmap, field, codepoints or indices. At S904, the receiving PDCP entity receives the indication(s) in the PDCP header of the PDCP SDU(s) of the frame and utilize for reordering and/or delivery of the frame e.g. frame is delivered only when it is completely received.

FIG. 10 is a flow chart (S1000) illustrating a PDCP delivery mechanism upon reordering timer expiry at the transmitting PDCP entity for the XR in the wireless network (1000), according to embodiments as disclosed herein. The operations (S1002-S1008) are handled by the PDCP discard controller (240).

At S1002, upon expiry of the t-Reordering timer, the receiving PDCP entity delivers to upper layers in ascending order of the associated COUNT value after performing header decompression, if not decompressed before: all stored PDCP SDU(s) pertaining to completely received frame with associated COUNT value(s)<RX_REORD, and all stored PDCP SDU(s) pertaining to completely received frame with consecutively associated COUNT value(s) starting from RX_REORD.

At S1004, the receiving PDCP entity discards all stored PDCP SDU(s) pertaining to not completely received frame (i.e. PDU Set) with associated COUNT value(s)<RX_REORD. At S1006, the receiving PDCP entity updates RX_DELIV to the COUNT value of the first PDCP SDU which has not been delivered to upper layers, with COUNT value>=RX_REORD. At S1008, the receiving PDCP entity updates RX_REORD to RX_NEXT, and starts t-Reordering timer If RX_DELIV<RX_NEXT.

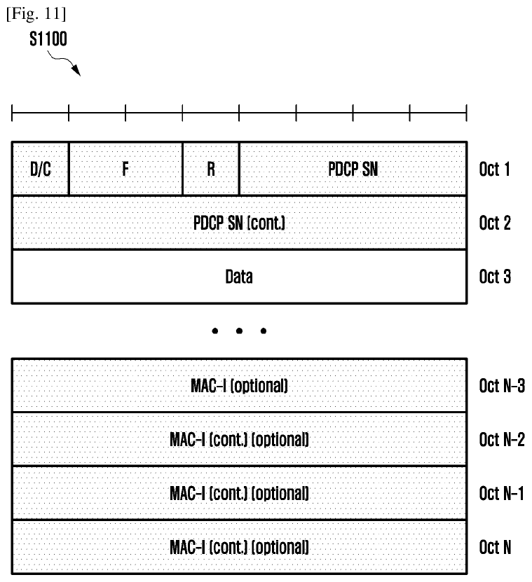

FIGS. 11-14 illustrate a various sample XR bearer data PDU format (1100-1400) with one or more sequence number, frame indicator field sub-sequence number field, according to embodiments as disclosed herein.

In an embodiment, the FIG. 11 is a sample XR bearer data PDU format (1100) with 12 bit sequence number and 2 bit Frame indicator field.

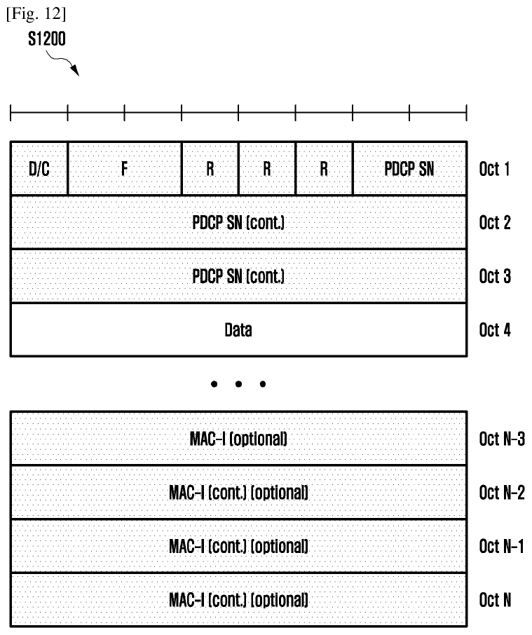

In an embodiment, the FIG. 12 is a sample XR bearer data PDU format (1200) with 18 bit sequence number and 2 bit Frame indicator field.

Parameter F description, Length: 2 bit, the field indicates the position of the PDCP SDU in a XR frame (i.e. PDU Set) such as start or end of the frame and is used by the reception entity to determine if the whole frame has been received fully as shown in Table-2.

### Bit Description

00 Continuing frame (in-between SDU)
01 First SDU of a frame (first segment of frame)
10 Last SDU of a frame (last segment of frame)
11 Whole frame without segments

### Table-2 (F-Field)

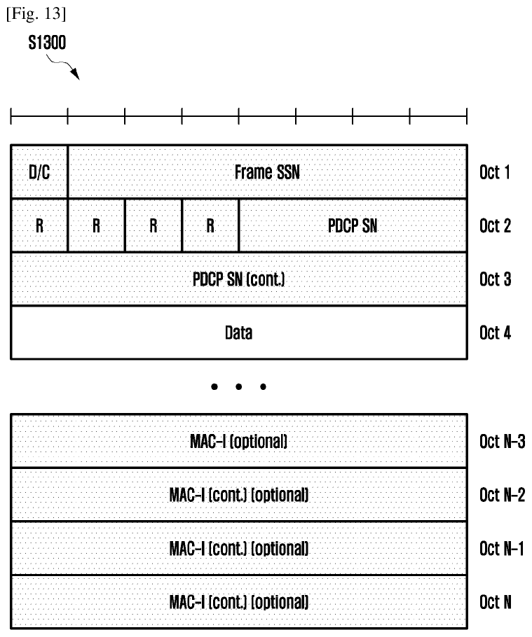

In an embodiment, the FIG. 13 is a sample XR bearer data PDU format (1300) with 12 bit sequence number and 7 bit Frame sub-sequence number (SSN) field.

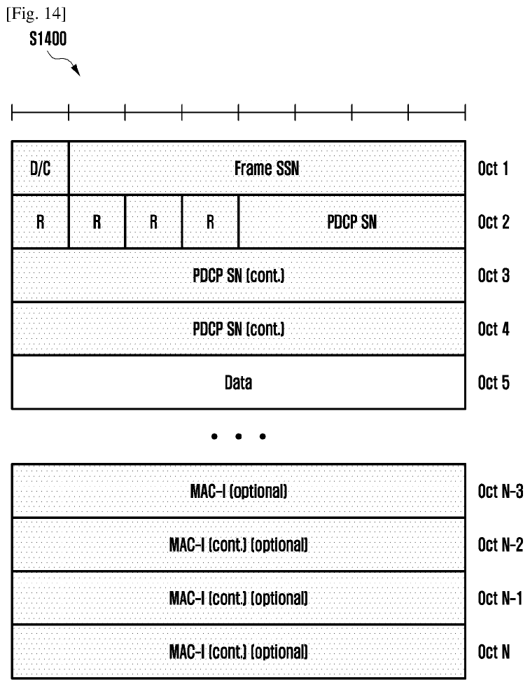

In an embodiment, the FIG. 14 is a sample XR bearer data PDU format (1400) with 18 bit sequence number and 7 bit Frame sub-sequence number field.

Parameter Frame SSN description,Length: 7 bits, the field indicates the position of the PDU in a XR frame by using the sub-sequence number. The receive entity uses the Frame SSN to reorder the SDUs within a frame.

The method provides an efficient and effective PDCP discard operation ensuring timely delivery of packets and saving of transmission resources for XR applications. Thus, the UE (300) and network XR service performance gains significantly with efficient transmission resource usage and lower latency.

The various actions, acts, blocks, steps, or the like in the flow charts (S400-S1000) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a transmitter in a wireless communication system, the method comprising:
receiving, from an upper layer, a packet data convergence protocol (PDCP) service data unit (SDU);
starting, based on reception of the PDCP SDU, an extended reality (XR) discard timer for a protocol data unit (PDU) set associated with the PDCP SDU, wherein the PDU set includes a PDCP PDU corresponding to the PDCP SDU; and
in case that the XR discard timer expires, discarding PDCP PDUs of the PDU set.

2. The method of claim 1, wherein, in case that at least one PDCP PDU of the PDU set is lost, the PDCP PDUs of the PDU set is discarded.

3. The method of claim 1, wherein a value of the XR discard timer is configured based on a radio resource control (RRC) message, wherein the value of the XR discard timer is associated with a type of the PDU set, and
wherein the RRC message includes a PDU set discard indication indicating discard of all PDCP PDUs of the PDU set.

4. The method of claim 1, wherein a PDCP header of the PDCP PDU includes information associated with a start of the PDU set and information associated with an end of the PDU set.

5. A method performed by a receiver in a wireless communication system, the method comprising:
receiving, from a transmitter, a packet data convergence protocol (PDCP) protocol data units (PDUs) of a PDU set;
identifying whether all PDCP PDUs of the PDU set is received based on PDCP headers of the PDCP PDUs in case that a PDU set delivery indication is configured; and
in case that the all PDCP PDUs of the PDU set is received, delivering, to an upper layer, PDCP service data units (SDUs) corresponding to the all PDCP PDUs of the PDU set.

6. The method of claim 5, wherein receiving the PDCP PDU further comprises:
in case that the PDU set delivery indication is not configured, reordering the PDCP PDUs of the PDU set based on the PDCP headers; and
delivering PDCP SDUs corresponding to the PDCP PDUs of the PDU set.

7. The method of claim 5, wherein the PDU set delivery indication is configured based on a radio resource control (RRC) message.

8. The method of claim 5, wherein the PDCP headers includes information associated with a start of the PDU set and information associated with an end of the PDU set.

9. An apparatus in a wireless communication system, the apparatus comprising:
a transceiver; and
a controller coupled with the transceiver and configured to:
receive, from an upper layer, a packet data convergence protocol (PDCP) service data unit (SDU),
start, based on reception of the PDCP SDU, an extended reality (XR) discard timer for a protocol data unit (PDU) set associated with the PDCP SDU, wherein the PDU set includes a PDCP PDU corresponding to the PDCP SDU, and
in case that the XR discard timer expires, discard PDCP PDUs of the PDU set.

10. The apparatus of claim 9, wherein, in case that at least one PDCP PDU of the PDU set is lost, the PDCP PDUs of the PDU set is discarded.

11. The apparatus of claim 9, wherein a value of the XR discard timer is configured based on a radio resource control (RRC) message, wherein the value of the XR discard timer is associated with a type of the PDU set, and
wherein the RRC message includes a PDU set discard indication indicating discard of all PDCP PDUs of the PDU set.

12. The apparatus of claim 9, wherein a PDCP header of the PDCP PDU includes information associated with a start of the PDU set and information associated with an end of the PDU set.

13. An apparatus in a wireless communication system, the apparatus comprising:
a transceiver; and
a controller coupled with the transceiver and configured to:
receive, from a transmitter, a packet data convergence protocol (PDCP) protocol data units (PDUs) of a PDU set;
identify whether all PDCP PDUs of the PDU set is received based on PDCP headers of the PDCP PDUs in case that a PDU set delivery indication is configured; and
in case that the all PDCP PDUs of the PDU set is received, deliver, to an upper layer, PDCP service data units (SDUs) corresponding to the all PDCP PDUs of the PDU set.

14. The apparatus of claim 13, wherein the controller is configured to:
in case that the PDU set delivery indication is not configured, reorder the PDCP PDUs of the PDU set based on the PDCP headers, and deliver PDCP SDUs corresponding to the PDCP PDUs of the PDU set.

15. The apparatus of claim 13, wherein the PDU set delivery indication is configured based on a radio resource control (RRC) message, and wherein the PDCP headers includes information associated with a start of the PDU set and information associated with an end of the PDU set.
